(19) United States
(12) Patent Application Publication
(10) Pub. No.: US 2012/0297837 A1
(43) Pub. Date: Nov. 29, 2012

(54) METHOD FOR PRODUCING GLASS PREFORM

(75) Inventor: Tomohiro Ishihara, Yokohama-shi (JP)

(73) Assignee: SUMITOMO ELECTRIC INDUSTRIES ,LTD., Osaka-shi ,Osaka (JP)

(21) Appl. No.: 13/574,895

(22) PCT Filed: Apr. 28, 2011
(86) PCT No.: PCT/JP2011/060363

§ 371 Date: Jul. 24, 2012

(30) Foreign Application Priority Data
Apr. 30, 2010 (JP) 2010-105546

(51) Int. Cl. C03B 37/018

(52) U.S. Cl. 65/422; 65/421

(57) ABSTRACT

Provided is a method for manufacturing glass preforms which is suitable for making an optical fiber having a less transmission loss in the wavelength band of 1.38 μm. The glass-preform manufacturing method of the present invention enables making a glass preform through a fixing step, a deposition step, an extraction step, a vitrification step, and a collapsing step in the named order. At the vitrification step, a glass soot body 13 with an integral tubular handle 12 is put in a heating furnace 22 in which He gas and Cl₂ gas are introduced, so that it is heated with a heater 23. Thus, a consolidated glass pipe 14 is produced. A dry gas is introduced in the heating furnace 22 upon production of the consolidated glass pipe 14, and the consolidated glass pipe 14 is cooled under the conditions where the humidity of atmosphere around the outer circumference of the consolidated glass pipe 14 is maintained at 0.1% or less.

### TECHNICAL FIELD

The present invention relates to a method of manufacturing a glass preform for an optical fiber.

### BACKGROUND ART

An optical fiber is produced by drawing a glass preform having a substantially columnar form into a fiber by heating and softening an end thereof. The glass preform for such optical fiber is manufactured by a manufacturing method, such as OVD method or MCVD method. Japanese translation of PCT international application No.2002-543026 (Patent Literature 1) discloses a method of manufacturing a glass preform by OVD method.

The glass-preform manufacturing method disclosed in Patent Literature 1 is intended to produce a glass preform for an optical fiber with low water content. According to this manufacturing method, a glass soot body is produced by depositing glass particles on the circumferences of a starting member which consists of a tubular handle and a mandrel inserted therein, and then a glass soot body with a central hole extending along the axial direction is made by pulling out the mandrel from the glass soot body. Subsequently, the glass soot body is dehydrated by heating and consolidated, and then the central hole thereof is collapsed. Thus, a transparent glass preform is produced. As for the glass-preform manufacturing method disclosed in Patent Literature 1, occasionally there is a case where an optical fiber made by drawing a glass preform produced according to the method exhibits a large transmission loss in the wavelength band of 1.38 μm.

### SUMMARY OF INVENTION

### Technical Problem

The object of the present invention is to provide a method of manufacturing a glass preform which is suitable for making an optical fiber having a less transmission loss in the wavelength band of 1.38 μm in particular.

### Solution to Problem

According to the glass-preform manufacturing method of the present invention, a glass preform is produced through a fixing step S1, a deposition step S2, an extraction step S3, a vitrification step S4, and a collapsing step S5 in the named order. At the fixing step S1, a starting member is prepared by inserting a mandrel into a tubular handle and fixing together such that the tip portion of the mandrel protrudes from an end of the tubular handle. At the deposition step S2, a glass soot body is produced by depositing glass particles on the circumference of the starting member by subjecting the starting member and a glass synthesizing burner to relative two-way motions along the axial direction of the mandrel in a range extending from the tip portion of the mandrel to a part of the tubular handle. At the extraction step S3, the mandrel is extracted from the tubular handle and the glass soot body. At the vitrification step S4, a consolidated glass pipe is produced by heating the glass soot body in a heating furnace, and thereafter the consolidated glass pipe is cooled under the conditions where a dry gas is introduced into the heating furnace and the humidity of the atmosphere surrounding the outer circumference of the consolidated glass pipe is maintained at 0.1% or less. At the collapsing step S5, a solid glass preform is produced by reducing the pressure inside of the consolidated glass pipe and heating the consolidated glass pipe.

In the glass-preform manufacturing method of the present invention, it is preferable that chlorine gas be introduced into the inside of a consolidated glass pipe when the pressure inside of the glass pipe is reduced at the collapsing step. Also, the amount of such introduction of chlorine gas per minute (SLM) is preferably one half or more of the internal volume of the consolidated glass pipe.

### Advantageous Effects of the Invention

With the glass-preform manufacturing method of the present invention, it is possible to manufacture a glass preform suitable for producing an optical fiber having less transmission loss in the wavelength band of 1.38 μm.

### BRIEF DESCRIPTION OF THE DRAWINGS

FIG. 1 is a flow chart of the glass-preform manufacturing method relating to an embodiment of the present invention.

FIG. 2 is a conceptional schematic diagram illustrating the fixing step S1 of the glass-preform manufacturing method of FIG. 1.

FIG. 3 is a conceptional schematic diagram illustrating the deposition step S2 of the glass-preform manufacturing method of FIG. 1.

FIG. 4 is a conceptional schematic diagram illustrating the extraction step S3 of the glass-preform manufacturing method of FIG. 1.

FIG. 5 is a conceptional schematic diagram illustrating the vitrification step S4 of the glass-preform manufacturing method of FIG. 1.

FIG. 6 is a conceptional schematic diagram illustrating the collapsing step S5 of the glass-preform manufacturing method of FIG. 1.

### DESCRIPTION OF EMBODIMENT

Hereinafter, preferred embodiments of the present invention will be described in reference to the accompanying drawings. The drawings are provided for the purpose of explaining the embodiments and are not intended to limit the scope of the invention. In the drawings, an identical mark represents the same element so that the repetition of explanation may be omitted. The dimensional ratios in the drawings are not always exact.

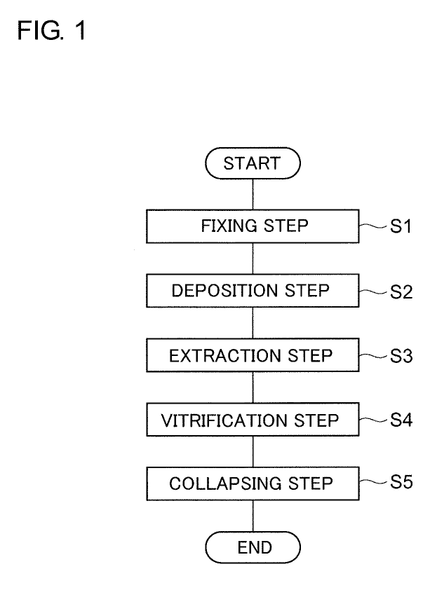

FIG. 1 is a flow chart of the glass-preform manufacturing method relating to an embodiment of the present invention. With the glass-preform manufacturing method of FIG. 1, glass preforms are produced through the fixing step SI, the deposition step S2, the extraction step S3, the vitrification step S4, and the collapsing step S5 in the named order. The glass preform to be manufactured with this glass-preform manufacturing method may be either an optical fiber preform that will be drawn into an optical fiber as it is, or a core preform that will be processed into the core part of an optical fiber, for example.

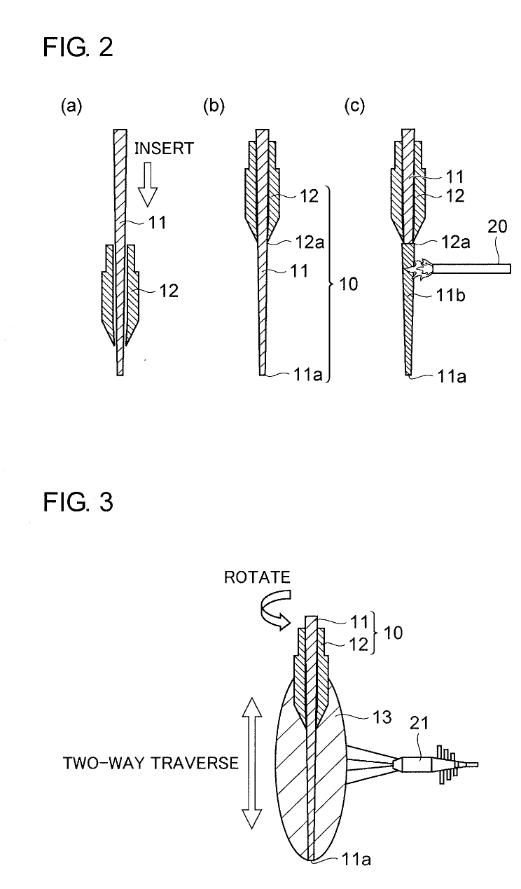

FIG. 2 is a conceptional schematic diagram illustrating the fixing step S1. At the fixing step S1, a mandrel 11 is inserted into a tubular handle 12 and fixed thereto such that the tip portion 11a of the mandrel 11 protrudes from an end 12a of the tubular handle 12, and thereby a starting member 10 is prepared (Regions (a) and (b) of FIG. 2). The mandrel 11 is made of alumina, glass, fireproof ceramics, or carbon, for example. The tubular handle 12 is made of silica glass.

It is preferable that a carbon membrane 11b be formed, by flames from a burner 20 such as a city gas burner, an acetylene burner, or the like, on the circumference of the portion of the starting mandrel 11 that protrudes from an end 12a of the tubular handle 12 in the starting member 10 (Region (c) of FIG. 2). During such formation of carbon membrane, the starting member 10 rotates using the central axis of the mandrel 11 as its center, and the burner 20 repeats two-way motion in relation to the starting member 10 and along the axial direction of the starting mandrel 11.

FIG. 3 is a conceptional schematic diagram illustrating the deposition step S2. At the deposition step S2, the starting member 10 rotates using the central axis of the mandrel 11 as its center. A glass synthesizing burner 21 arranged on the side of the starting member 10 and forming oxy-hydrogen flames repeats the relative two-way motion with respect to the starting member 10 and along the axial direction of the mandrel 11. Thus, glass particles are deposited on the circumference of the starting member 10 by the OVD method, covering a part of the tubular handle 12 and the tip portion 11a of the starting mandrel 11. In this manner, a glass soot body 13 is produced.

At the deposition step S2, the flow of materials supplied to the glass synthesizing burner 21 is adjusted at every traverse (from the tip portion 11a of the mandrel 11 to a part of the tubular handle 12, or from a part of the tubular handle 12 to the tip portion 11a of the mandrel 11). Thus, the glass soot body formed on the circumference of the mandrel 11 will have a predetermined radial distribution of composition (namely, the radial refractive-index profile of a glass preform or an optical fiber which will be produced therefrom later).

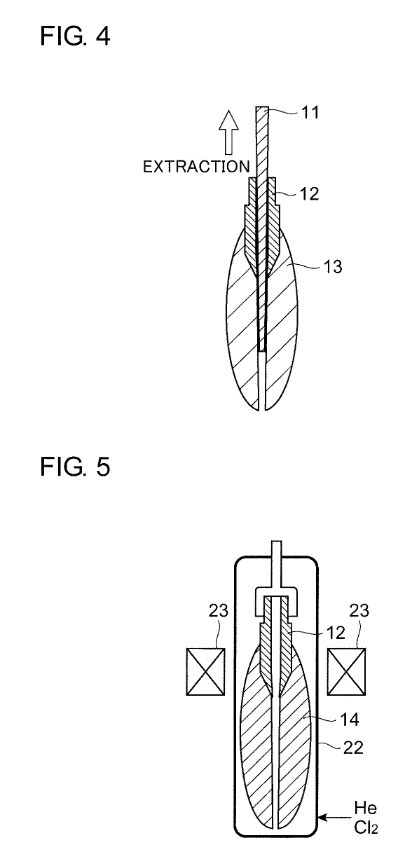

FIG. 4 is a conceptional schematic diagram illustrating the extraction step S3. At the extraction step S3, the mandrel 11 is pulled out from the tubular handle 12 and the glass soot body 13. In such case, the tubular handle 12 and the glass soot body 13 remain in a state as fixed together. Note that if a carbon membrane is formed beforehand on the circumference of the portion of the mandrel 11 protruding from the end 12a of the tubular handle 12 at the fixing step S1, the inner wall surface of the central hole in the glass soot body 13 will be prevented from being damaged when the mandrel 11 is pulled out at the extraction step S3.

FIG. 5 is a conceptional schematic diagram illustrating the vitrification step S4. At the vitrification step S4, the glass soot body 13 is put, integrally with the tubular handle 12, in the heating furnace 22 into which helium gas and Cl₂ gas are fed, and the glass soot body 13 is heated with a heater 23. Thus, a consolidated glass pipe 14 is produced.

At the vitrification step S4, a dry gas is introduced into the heating furnace 22 immediately after the vitrification of the consolidated glass pipe 14, and the consolidated glass pipe 14 is gradually cooled under the conditions where the humidity of atmosphere around the outer circumference of the consolidated glass pipe 14 is maintained at 0.1% or less. Here, the humidity is defined by the formula: the humidity (%)=100×moisture weight in a volume/dry gas weight in the volume. When the consolidated glass pipe 14 is cooled to a temperature of 100° C. to 600° C. from the temperature of the glass pipe immediately after the vitrification, the consolidated glass pipe 14 is removed from the heating furnace 22. The humidity of the atmosphere surrounding the outer circumference of the consolidated glass pipe 14 is controlled based on the humidity of gas exhausted from the heating furnace by adjusting the flow rate of the humidity controlled dry gas supplied to the heating furnace. Note that nitrogen or argon gas, which is low cost, is suitable for use as such dry gas.

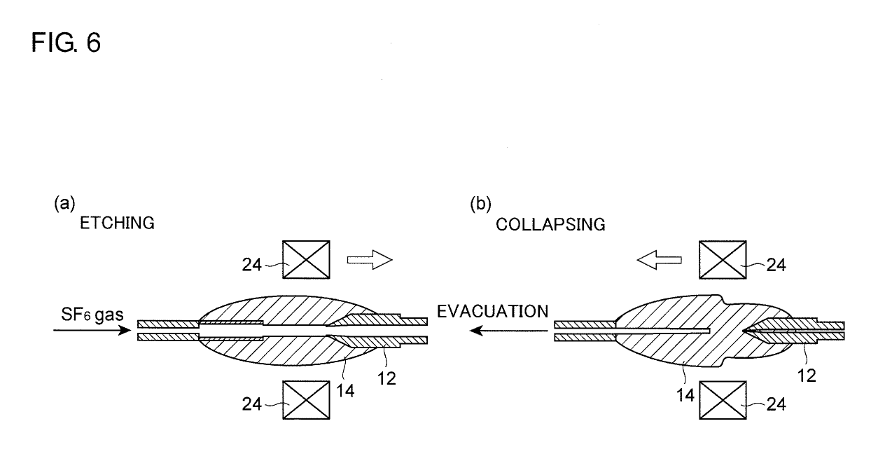

FIG. 6 is a conceptional schematic diagram illustrating the collapsing step S5. At the collapsing step S5, a consolidated glass pipe 14 is put in a heating furnace and rotated, and SF₆ is introduced into its central hole, while it is heated with the heater 24, resulting in vapor-phase etching of the inner wall surface of the central hole (Region (a) of FIG. 6). Subsequently, the consolidated glass pipe 14 is heated with the heater 24 while the pressure inside of the glass pipe is reduced, resulting in collapse, so that a solid glass preform is formed (Region (b) of FIG. 6).

At the collapsing step S5, it is preferable to introduce chlorine gas into the inside of the consolidated glass pipe 14 when the pressure inside of the glass pipe is reduced. Moreover, when the chlorine gas is introduced into the consolidated glass pipe 14, preferably the amount of such introduction of chlorine gas per minute (SLM) is not less than one half of the inside volume of the consolidated glass pipe.

The transparent glass preform thus prepared is subjected to further processing, such as formation of a cladding layer provided thereon, vitrification processing, etc., resulting in an optical fiber preform. Furthermore, a tip of the optical fiber preform is drawn by heat-softening, so that an optical fiber is produced.

In an embodiment of the present invention, at the vitrification step S4, dry gas is introduced into the heating furnace 22 while the temperature of the heating furnace is being lowered immediately after the vitrification of the consolidated glass pipe 14, and the consolidated glass pipe 14 is cooled gradually under the conditions where the humidity in the atmosphere around the outer circumference of the consolidated glass pipe 14 is maintained at 0.1% or less. Maintaining the humidity at 0.1% or less in the atmosphere around the outer circumference of the consolidated glass pipe 14 enables reducing the OH groups contained in a glass preform. This enables decreasing the transmission loss in the 1.38 μm wavelength band of an optical fiber that is obtained by drawing the glass preform. Moreover, the cost for manufacturing a glass preform can be reduced by using low-cost nitrogen gas or argon gas for cooling, rather than using the expensive helium gas used at the vitrification step S4.

Moreover, preferably at the collapsing step S5 in the embodiment of the present invention, chlorine gas is introduced into the inside of the consolidated glass pipe 14 when the pressure inside of the consolidated glass pipe 14 is reduced. Generally, the pressure inside of the central hole of a consolidated glass pipe is reduced for collapsing the hole at a collapsing step, and hence the atmosphere tends to easily mix into the hole. Since water (OH radical) is contained in such atmosphere, the OH will spread into the glass from the inner wall surface of the hole of the consolidated glass pipe having high temperature. Because of such mechanism, the transmission loss (especially transmission loss in the 1380 nm band) of the optical fiber increases. Therefore, according to the embodiment of the present invention, the water mixed into the hole of the consolidated glass pipe 14 can be made harmless by introducing chlorine gas into the hole while the pressure inside of the hole is reduced.

Furthermore, according to the embodiment of the present invention, the amount of chlorine gas introduced inside the consolidated glass pipe 14 per minute (SLM) at the collapsing step S5 is preferably not less than one half of the inside volume of the consolidated glass pipe 14. This enables replacing the inside of the hole with chlorine within two minutes, resulting in elimination of water in the hole before the water spreads inside the consolidated glass pipe 14. Note that if the amount (SLM) of such chlorine gas introduction per minute is less than one half of the inside volume of the consolidated glass pipe, it takes time for removing the water in the hole of the consolidated glass pipe, and accordingly OH will occasionally spread into the glass from the inner wall surface of the hole.

### EXAMPLE

In Examples 1 to 6, glass preforms for making single mode optical fibers by drawing them are prepared. At the deposition step S2, OVD equipment is used for deposition of glass particles. An alumina rod having an outer diameter of 9 to 10 mm and a length of 1200 mm is used as the mandrel 11. And, a silica glass pipe having a length 600 mm, an outer diameter of 20 to 40 mm, and an inner diameter of 9.8 to 21 mm is used as the tubular handle 12.

The glass-material gas supplied to a glass synthesizing burner 21 for forming an oxy-hydrogen flame is SiCl₄ (Supply amount: 1 to 3 SLM/piece) and GeCl₄ (Supply amount: 0.0 to 0.1 SLM). The velocity of the relative motion of the starting member 10 with respect to the glass synthesizing burner 21 is 3 to 1500 mm/minute, and the revolving speed of the starting member 10 is 60 rpm.

The vitrification step S4 is conducted after the deposition step S2 and the extraction step S3. At the vitrification step S4, a glass soot body 13 having a central hole is held at an upper part in a heating furnace, and the temperature of the heating furnace is raised to a desired temperature in a range of 1000° C. to 1350° C., while helium gas (15 SLM) and chlorine (1 SLM) are introduced into the heating furnace. When the temperature inside the heating furnace has reached a desired value, the glass soot body 13 is moved downward from the upper part at a desired velocity in a range of 2 to 10 mm per minute, so that it is dehydrated. When the glass soot body 13 has reached the lowest end, the glass soot body 13 is pulled upwards at a speed of 1000 mm/minute, while helium gas (20 SLM) is introduced into the heating furnace whose temperature is being raised. When the temperature of the heating furnace has reached a desired value in the range of 1450° C. to 1600° C., the glass soot body 13 is moved downward from the upper part at a desired speed in a range of 2 to 6 mm per minute. Thus, the vitrification of the glass soot body 13 is accomplished, thereby making a consolidated glass pipe 14.

When the consolidated glass pipe 14 has reached the lowest end, the consolidated glass pipe 14 is pulled upwards at a speed of 1000 m/minute, and the decreasing of temperature in the heating furnace is commenced. Also, at the same time as the consolidated glass pipe 14 has reached the lowest end, nitrogen gas is introduced into the heating furnace at 15 SLM, and the temperature of the consolidated glass pipe 14 is being lowered under the conditions where the humidity of the atmosphere around the consolidated glass pipe 14 is controlled at 0.1% or less. When the temperature of the consolidated glass pipe 14 reaches 300° C., the consolidated glass pipe 14 is removed from the heating furnace.

The collapsing step S5 is performed after the vitrification step S4. At the collapsing step S5, the consolidated glass pipe 14 is put in a heating furnace and rotated at 30 rpm, while the consolidated glass pipe 14 is heated to a temperature in a range of 1900° C. to 2200° C. with a heating furnace (heater), which moves at a velocity of 5 to 20 mm/minute in the longitudinal direction of the consolidated glass pipe 14. The heating means at the collapsing step S5 may be an oxy-hydrogen burner, or a heat source such as a carbon heater or a heating element using an electromagnetic induction coil. In such case, SF₆ gas is flowed at a rate of 50 to 100 sccm inside the central hole of the consolidated glass pipe 14, and vapor-phase etching is done in a region of 1.5 to 2.5 mm in the radial direction from the inner wall surface of the central hole of the consolidated glass pipe 14. Subsequently, the pressure inside of the central hole is reduced to 0.1 to 10 kPa, and the consolidated glass pipe 14 is collapsed at the same temperature as that of etching, so that a glass preform is produced. In such case, the volume of the consolidated glass pipe 14 before collapsing is 0.03 L, and the amount of chlorine gas introduced for collapsing is 0.015 to 0.2 SLM.

The glass preform prepared in this way is elongated to have a desired diameter, and a jacket glass is provided around the outer circumference by the OVD method, whereby a glass preform for an optical fiber is produced. Such glass preform for an optical fiber is drawn, whereby a single-mode fiber is manufactured.

Table summarizes the following with respect to each of Examples 1 to 6 and Comparative Examples: humidity A(%) that is prevailing immediately after production of consolidated glass pipes around the circumference thereof; amount B (SLM) of chlorine gas introduced into the hole of the consolidated glass pipe at the collapsing step; and OH absorption loss Z (dB/km) at the wavelength of 1.38 μm with respect to an optical fiber produced by drawing a glass preform prepared in such manner.

TABLE

| | | Chlorine gas | |
|---|---|---|---|
| | Humidity A | introduction | Z |
| | (%) | amount B (SLM) | (dB/km) |
| Example 1 | 0.01 | 0.015 | 0.49 |
| Example 2 | 0.1 | 0.015 | 0.52 |
| Comparative example 1 | 0.12 | 0.015 | 1.1 |
| Comparative example 2 | 0.3 | 0.015 | 4 |
| Comparative example 3 | 2 | 0.015 | 11 |
| Example 3 | 0.1 | 0.2 | 0.38 |
| Example 4 | 0.1 | 0.15 | 0.4 |
| Example 5 | 0.1 | 0.011 | 0.65 |
| Example 6 | 0.1 | 0 | 0.9 |

If the humidity A is 0.1% or less, the OH absorption loss Z will be reduced. Moreover, if the chlorine gas introduction amount B (SLM) is one half or more relative to the internal volume of a consolidated glass pipe, the OH absorption loss Z of an optical fiber will be more reduced at the 1.38 μm wavelength.

1. A glass-preform manufacturing method comprising:
a fixing step for preparing a starting member by inserting a mandrel into a tubular handle, the mandrel and the tubular handle being fixed together such that the tip portion of the mandrel protrudes from an end of the tubular handle;
a deposition step for producing a glass soot body by depositing glass particles on the circumference of the starting member by subjecting the starting member and a glass synthesizing burner to relative two-way motions along the axial direction of the mandrel in a range extending from the tip portion of the mandrel to a part of the tubular handle;
an extraction step for pulling out the mandrel from the tubular handle and the glass soot body;
a vitrification step for producing a consolidated glass pipe by heating the glass soot body in a heating furnace and thereafter cooling the consolidated glass pipe under the conditions where a dry gas is introduced into the heating furnace and the humidity of atmosphere surrounding the outer circumference of the consolidated glass pipe is maintained at 0.1% or less; and
a collapsing step for producing a solid glass preform by reducing the pressure inside of the consolidated glass pipe while heating the consolidated glass pipe.

2. A glass-preform manufacturing method according to claim 1, wherein
chlorine gas is introduced into the inside of the consolidated glass pipe when the pressure inside of the glass pipe is reduced at the collapsing step.

3. A glass-preform manufacturing method according to claim 2, wherein
the amount of chlorine gas introduction per minute (SLM) is one half or more of the internal volume of the consolidated glass pipe.
